(19) United States
(12) Patent Application Publication
(10) Pub. No.: US 2007/0108265 A1
(43) Pub. Date: May 17, 2007

(54) Currency note identification and validation

(75) Inventor: Peter Ronald Smith, Essendon (AU)

Correspondence Address: MERCHANT & GOULD PC, P.O. BOX 2903, MINNEAPOLIS, MN, 55402-0903, US

(73) Assignee: ASTROSYS INTERNATIONAL LTD., Kowtoon (CN)

(21) Appl. No.: 10/558,915

(22) PCT Filed: May 6, 2004
(86) PCT No.: PCT/AU04/00587

§ 371 Date: Oct. 19, 2006

(30) Foreign Application Priority Data
May 30, 2003 (AU) 2003902702

(51) Int. Cl. G07F 19/00

(52) U.S. Cl. 235/379

(57) ABSTRACT

Currency note identification and validation apparatus includes means defining a note path from a presentation position, and sensor means to identify at least one position parameter of a note as it traverses the note path. Scan head means responsive to identification of said at least one position parameter of the note to inspect a selected first zone of the note for making a provisional identification of the note, and positionable to inspect a second zone of the note selected in dependence on the provisional identification and on the identification of the position parameter, for validating the provisional identification.

### FIELD OF INVENTION

This invention relates generally to the identification and validation of currency notes. Although the invention is of wide application, it is especially applicable to the identification and validation of paper currency in change dispensers, pay stations, vending machines and other equipment where payment is made or an operation enabled by insertion of a currency note. Currency notes are also known as banknotes, paper money or bills.

### BACKGROUND ART

Known currency note validators generally have a housing that defines a path comprising a flat bed along which each note is propelled from an insertion slot, usually by a transport system comprising friction belts or drive rollers. The note is thereby moved past an array of sensors that each record a response trace for the note as it passes. These traces are then compared with a bank of reference traces for valid notes. A note validated in this way is propelled onto storage, and its value may trigger an operation or may be recorded as a credit towards an operation. A note not validated is typically propelled back out the insertion slot by reversal of the transport system.

By convention, the four different ways a note can be fed into a validator are treated as four different denominations of the same value. This convention is adopted throughout this specification.

Current devices use an array of sensors, typically reflective, transmissive, magnetic and ultraviolet, arranged in a flight deck so that as a note passes over them, they provide data representative of the pattem, colour and magnetic properties of the printing ink as well as the opacity of the note paper. Typically, the sensors are located in fixed positions either side of the note path and the note moves longitudinally between them. The data from each sensor is actually a response to a trace corresponding to the position of each sensor along the length of the note.

This method has serious limitations. Because the sensors are fixed, the position of the trace along each note is the same irrespective of where the most sensitive information is located on the note. Where notes of different denominations are to be validated, the optimum position of each trace for a particular sensor will vary from one denomination to another but because the position is fixed, significant information and data is missed. For example, the bank govemor's signature on a particular series of notes of different denominations may be printed with magnetic ink. The magnetic sensor may be placed so that the trace for one denomination passes over the signature but if the signature is in a different position on another denomination, then it will not be detected.

The accuracy of the conventional system depends upon the ability of the device to pass the note across the sensor in the same relative position each time, so that each of the sensors traverses the same portion of the note, thus returning the same data. Where the denominations in a particular currency set vary with width, there is a problem with lateral location because the note guides must be wide enough to allow the widest note to pass, which then allows the narrow notes to wander sideways, thus varying the position of the sensor traces along the note. Although there are some devices fitted with mechanical centering arrangements, they are complicated and prone to damage.

A similar problem exists where a note is entered into the device so that its longitudinal axis is not parallel with that of the device, ie it is skewed. As the note passes through the device, the trace across each sensor moves at an angle across the note thus corrupting the data. Skewed notes can also jam stackers attached to the validation unit because they can enter at an angle to the stacking mechanism.

The validation accuracy also depends upon the ability of the device to correlate the data at any point along the trace with the longitudinal position along the note. The longitudinal position of a note is determined by the movement of the transport system once it has engaged the note and this is clocked with each data point along each sensor trace. The problem is that the note can slip relative to the transport system, with the result that the data along the trace is corrupted because conventional practice clocks movement of the transport system.

The problem is further exacerbated when the note is of a type printed onto a large plain sheet and then cut from the sheet, leaving a border around the printed pattem on the note. For most notes, this border is not cut accurately thereby offsetting the data in each sensor trace by the variation in the border from one note to another. Once again, this corrupts or distorts the data along each sensor trace.

Because notes can be inserted in any of four different ways, the sensors in existing devices are generally duplicated either side of the centre line of the note path to ensure, as far as possible, that relevant data is gathered irrespective of which way the note is inserted. This arrangement ensures that the number of sensors is at least double the minimum required and adds significant cost to the device.

U.S. Pat. No. 5,652,802 discloses a currency note discriminator able to distinguish between plural denominations of a range of different currencies. The described approach continues to rely on sensor scans along fixed straight lines longitudinally of the note, but in this case the sensors are provided on scan heads that are laterally adjustable to allow pre-selection of the fixed straight line scans. The lateral positioning of the scan heads may be in dependence on the output of a note edge detector, or of note size measurement by multiple edge detectors. Also disclosed is a line of sensors to correct for the note being askew. In response to detected note skew, either the laterally moveable scan heads are controlled, or the pattern processing accounts for the detected skew.

It is an object of the invention to at least in part alleviate one or more of these difficulties.

### SUMMARY OF THE INVENTION

In one aspect, the invention essentially involves a departure from the convention of a fixed and static structure, to adopt a dynamic approach that optimises a longitudinal scan in dependence on a provisional identification of the note using a lateral scan. In another aspect, the invention optimises the scan by laterally adjusting the scan head as the note passes, to allow data collection at known optimum positions or paths, preferably using the optimum sensor at each of those positions.

The invention accordingly provides, in a first aspect, currency note identification and validation apparatus that includes means defining a note path from a presentation position, and sensor means to identify at least one position parameter of a note as it traverses the note path. Scan head means is responsive to identification of said at least one position parameter of the note to inspect a selected first zone of the note for making a provisional identification of the note, and positionable to inspect a second zone of the note selected in dependence on the provisional identification and on the identification of the position parameter, for validating said provisional identification.

In its first aspect, the invention also provides a method of identifying and validating a currency note including:
identifying at least one position parameter of the note as it traverses a note path;
in dependence on identification of said at least one position parameter, inspecting a selected first zone of the note for making a provisional identification of the note; and
inspecting a second zone of the note selected in dependence on said provisional identification and on said identification of the position parameter, for validating said provisional identification.

Advantageously, said first zone is a zone laterally of the note, for example a linear zone. The first zone is typically common for all denominations of a currency set. The first zone may entail a single pass or plural passes over the note.

The second zone is preferably a zone longitudinally of the note. The second zone may typically be variable between denominations of the same currency set.

The second zone is preferably such that the scan head means relatively adjusts its position laterally of the note as the second zone is inspected.

The scan head means may comprise a single scan head or set of scan heads for inspection of both the first and second zones, or it may comprise separate scan heads or sets of scan heads for the respective zones.

The first zone of the note is preferably selected to enhance or optimise the likelihood that the provisional identification of the note is correct. The selection may take into account an expectation that the notes are likely to be, or required to be, of a particular currency or range of currencies, eg. euros and British pounds. The selection is made by comparison of one or more sensor values for the first zone with pre-stored known data for the first zone.

In a second aspect, the invention provides a currency note validation apparatus including:
means defining a note path from a presentation position;
sensor means to identify at least one position parameter of a note as it traverses said note path; and
scan head means positionable to inspect a zone of the note selected in dependence on said identification of said position parameter, for validating said note;
wherein said zone is such that the scan head means relatively adjusts its position laterally of the note as the zone is inspected.

Preferably, means eg. a friction belt or rollers is provided to propel the note long said note path.

The means defining the note path may be a housing and said presentation position is conveniently a slot opening into said housing. The note path is preferably stepped or offset, eg. to prevent tampering by means of foreign objects and to reduce the effect of ambient light shining into the note path.

The scan head means is preferably one or a pair of complementary scan heads having a plurality of optical and/or magnetic sensors, eg. transmissive and/or reflective sensors, each adapted to record a response trace for the note as it passes.

The scan head means is preferably mounted for scanning movement over the respective note, as it traverses said zone, to vary its X-Y co-ordinates along the note. For example, the scan head means may be mounted on one or more guide rods, or on one or more pivoting arms.

### BRIEF DESCRIPTION OF THE DRAWINGS

The invention will now be further described, by way of example only, by reference to the accompanying drawings, in which:

FIG. 1 is a cross-section of currency note identification apparatus in the form of a banknote validation device, taken in a plane intersecting the note path;

FIGS. 2 and 3 are respectively an end view and a plan view of the device arrangement;

FIG. 4 schematically depicts the respective scan paths or zones across a note presented to the apparatus shown in FIGS. 1 to 3;

FIG. 5 is a view similar to FIG. 2 of a modified scan head configuration; and

FIGS. 6 and 7 are a pair of diagrams (plan and end views) showing how note skew is detected.

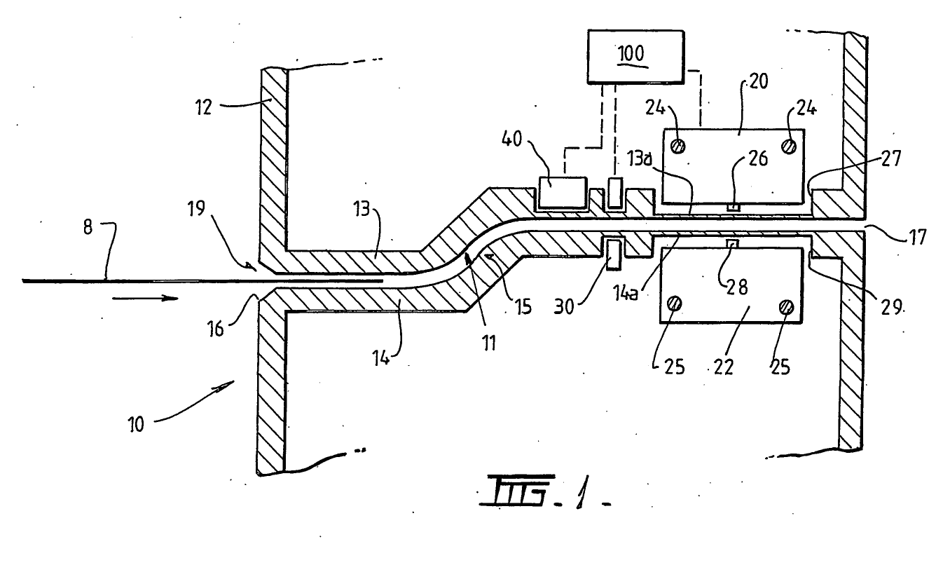

### EMBODIMENTS OF THE INVENTION

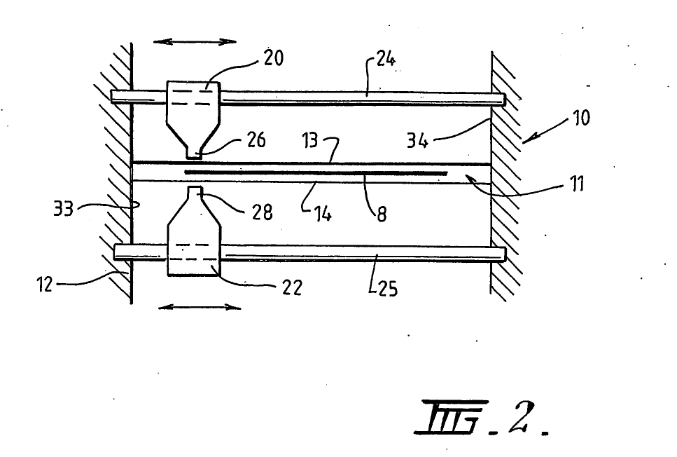

The illustrated banknote validation device 10 includes a housing 12 with close-spaced upper and lower flat walls 13, 14 and side walls 33, 34 (FIG. 2) that define, in the conventional manner, a note path 11 from a note entry opening 16 at a presentation position 19 to an exit 17. The note path is stepped or offset in the longitudinal axis at 15 to prevent tampering with foreign objects and to reduce the effect of ambient light shining into the note path. A banknote 8 presented at note entry opening 16 is engaged by a note transport system (not shown) such as a friction belt or series of rollers which propels the note along path 11 to exit 17.

The device 10 does not have conventional fixed discrimination sensors. Instead, the sensors are mounted on respective travelling opposed sensor heads 20, 22, in turn slidably mounted on pairs of guide rods 24, 25 for movement laterally across the passing note in channels 27, 29 formed in walls 13, 14. Thinned transparent webs 13a, 14a of walls 13, 14 separate sensor heads 20, 22 from the passing note. Each sensor head is driven laterally on guide rods 24, 25, which are typically threaded, by a stepper motor or other drive means (not shown). Sensor heads 20, 22 are positioned above and below the note path and are moved synchronously so as to maintain mutual alignment of the heads.

In an alternative arrangement, sensor heads 20, 22 are, instead of being slidable on rods 24, 25, mounted on one or more pivoting arms, and traversed over the note path by pivoting movement of the arms.

The sensors carried by sensor heads 20, 22 may typically include reflective sensors of various wavelengths, a transmissive sensor and an ultraviolet (UV) sensor. All sensors are arranged to operate through a common lens 26, 28 on each sensor head, switched on or off dependent on pre-selected optimum discrimination data for the note at any particular point in the scan zone. For this purpose, the common lens may, for example, have multiple switchable inputs associated with the respective sensors carried by one scan head. A magnetic sensor head could also be included on the sensor heads. These sensors can be fitted to upper and lower sensor heads in any combination.

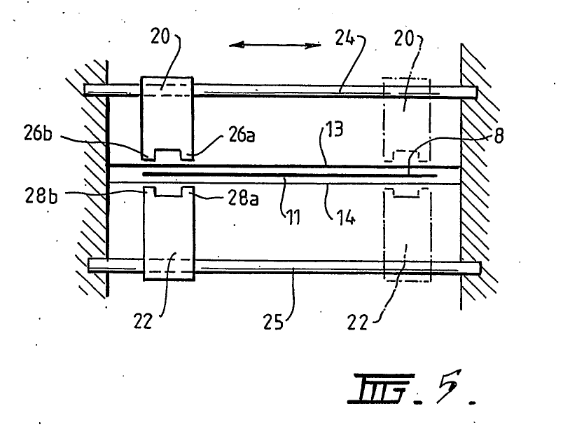

Alternatively, two common lenses 26a, 26b; 28a, 28b (FIG. 5) can be employed on each sensor head, to reduce the overall width of the device while still being able to scan the full width of a note.

The device has a transmissive trigger sensor 30 in front of the sensor head position which is used to trigger the entry of a note and actuate the aforementioned drive means. Further, this sensor can be used to indicate not only when a note is present, but when the transmitted light intensity falls within preset limits to indicate the position of not only the edge of the note, but also the edge of the note border, should there be one. The longitudinal position of the note is tracked by a laser movement sensor 40, which is mounted before the transmissive trigger sensor 30. The laser movement sensor is conveniently of the type that tracks actual note displacement rather than movement of the transport system, thus overcoming the prior difficulties arising from note slippage.

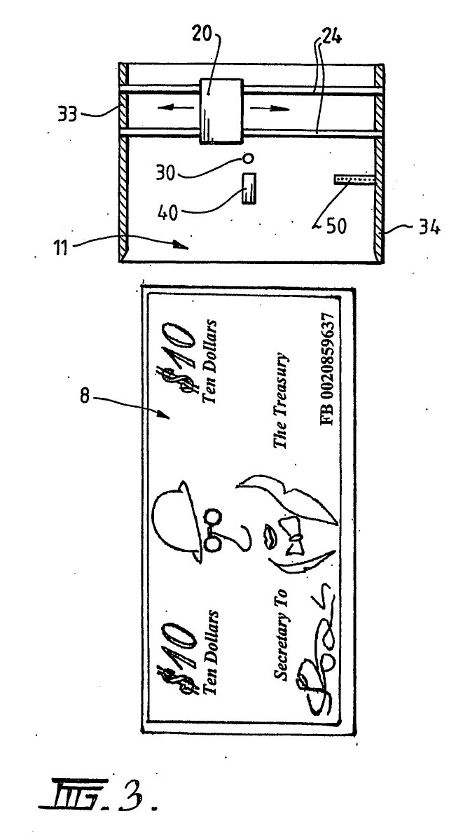

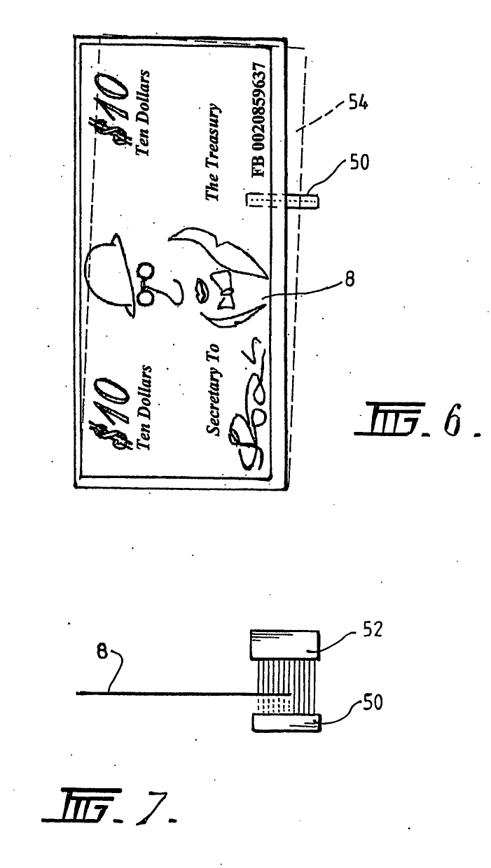

The lateral position of the note is tracked with a side sensor 50 (FIGS. 3, 6) using a linear phototransistor or CCD sensor array mounted at right angles to the edge of the note. The side sensor 50 uses the same laser light source 52 as the movement sensor. Sensor 50 is used to determine the lateral position of the note and consequently the amount of skew 54 (FIG. 6) as the note passes through the device, and to correct data position accordingly. It can also reject a note with too much skew which would otherwise jam a stacker downstream of exit 17.

Although not shown. a fixed ultraviolet sensor could be located after the sensor head to identify photocopied frauds which fluoresce.

Device 10 is equipped with a controller 100 including logic circuits that receives inputs from the various sensors, manages both note movement and scan head movement, and identifies notes presented to the device. Controller 100 is pre-programmed in the following manner. A separate scanning device (not the subject of this application), in conjunction with a computer, is used at factory level to scan each denomination in a currency set to determine the optimum longitudinal trace path along a note to pick up the most discriminatory features for each sensor against known or typical frauds. This path is generally not a straight line but effectively a series of predetermined scan points which can be selected at any position on the note. The resultant trace is similar to the children's game “join the dots”.

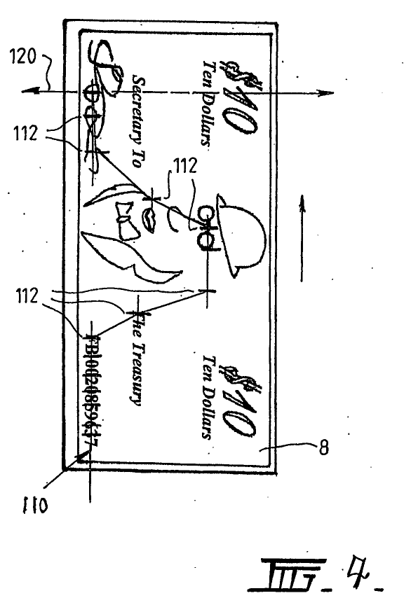

This factory scan also determines which sensor in the sensor heads provides the best discrimination at each point or along each path, and by this combination of optimum scan points and optimum sensors at each scan point, there is determined an optimum trace path joining the scan points. An exemplary longitudinal trace path is indicated at 110 in FIG. 4, joining scan points 112. The collected points 112 constitute a selected scan zone of the note. It will be appreciated that only a few scan points are shown: typically there would be hundreds of scan points, together defining an effectively continuous trace along the note.

The factory scanning process also determines the optimum position and sensor (or sensors) to make a lateral trace with scan heads 20, 22 across the note to determine what denomination it is within a currency set. The optimum lateral trace position could vary for each denomination in a particular currency but is typically at the same position for all denominations in a currency set. Typically, the position is within the first 20 mm from the leading edge of the note. Typically it is a straight line but could be dynamic.

The factory scanning process is also used to identify whether the note has a side border and how this information is to be used in the discrimination process.

The operation of the apparatus will now be described.

A note 8 is presented to note entry opening 16 and picked up by the note transport system. Longitudinal movement is tracked by the laser movement sensor 40 for the entire transition of the note along note path 11. As the leading edge passes over the trigger sensor 30, the device looks for an end border. It then determines how far to advance the note from the trigger point (which could be an end border or not) to the pre-determined lateral trace position. This constitutes a position parameter of the note as it traverses note path 11.

The note movement is now temporarily stopped as the scan heads 20, 22 perform a lateral scan 120 (FIG. 6) across the note to make a provisional identification of the note, in this case what denomination it is. This scan also determines the width of the note and in conjunction with the lateral side sensor 50 determines the lateral position of the note. The side scan also picks up the width of the side border of the note, if any.

Once the denomination is determined, the transport mechanism is reactivated and the note moves continuously and longitudinally through the device. Its longitudinal position from the trigger point is tracked by sensor 40 and its side position is tracked by side sensor 50. The longitudinal position, side position and adjustments for note border, if any, are used to accurately position the sensor heads 20, 22 at the predetermined discriminatory points 112 on the note 8 as it continues to traverse the device. At each pre-determined point 112, the device switches on the pre-determined sensor to collect the instantaneous data at that point. In the example shown in FIG. 4, the scan points 112 are shown as crosses and the scan path 110 joins these crosses together. It will be seen that as the note moves through, sensor heads 20, 22 move laterally of the note and note path to achieve each pre-programmed scan point. The scan is thus dynamic, in contrast to the static fixed straight line scan of previous devices.

This exemplary scan path is through the signature, looking for, say, a magnetic signal, and then through some discriminatory points on the face using perhaps the reflective wavelength sensors in conjunction with transmissive sensors. Then on to the heart-shaped water mark detected by the transmissive sensor. The trace then picks up a discriminatory point on the “T” and then passes through the serial number looking for known fraud serial number traces. For this last step, the scan heads are similar to a bar code reader.

Deviations of collected data from stored data are continuously assessed by the device to determine validity. As soon as the device determines that the note is not genuine, ie. the provisional identification is denied, it is rejected and reversed out of the device.

The side sensor 50 is used to determine the degree of skew and the note is rejected if it exceeds allowable limits, ie. it is likely to jam in the head or in the stacker where this is fitted.

Once the device detects the trailing edge of the note, the note is allowed to advance a set distance and the sensor heads 20, 22 perform another lateral scan to determine if a foreign object (such as a string) is attached which might be used in a fraud attempt, eg. to pull the note back out of the device. This scan is performed without stopping the note. Where a stacker is fitted at note exit 17, genuine notes ie. notes where the provisional identification has been confirmed, are moved into a stacker, also without stopping.

The lateral scan 120 and longitudinal scan 110 need not be limited to a predetermined path. With active scanning it is possible to make this path dynamic to a further degree in that it will vary depending on the data gathered during and up to that point of the scan event in progress. For example, the device might believe the note to be a particular fraud and could dynamically move to the serial number area and look for a known fraud serial number.

1. Currency note identification and validation apparatus including: means defining a note path from a presentation position; sensor means to identify at least one position parameter of a note as it traverses said note path; and scan head means responsive to identification of said at least one position parameter of the note to inspect a selected first zone of the note for making a provisional identification of the note, and positionable to inspect a second zone of the note selected in dependence on said provisional identification and on the identification of the position parameter, for validating said provisional identification.

2. Apparatus according to claim 1 wherein said first zone is a zone laterally of the note.

3. Apparatus according to claim 2 wherein said first zone is a linear zone.

4. Apparatus according to claim 2, wherein said second zone is a zone longitudinally of the note.

5. Apparatus according to claim 4, wherein said second zone is such that the scan head means relatively adjusts its position laterally of the note as the second zone is inspected.

6. Apparatus according to claim 1 wherein said scan head means comprises a single scan head or set of scan heads for inspection of both the first and second zones.

7. Apparatus according to claim 1 wherein said scan head means comprises separate scan heads or sets of scan heads for the respective first and second zones.

8. Apparatus according to claim 1, further including means to propel the note along said note path.

9. Apparatus according to claim 8, wherein said means defining the note path is a housing and said presentation position is a slot opening into said housing.

10. Apparatus according to claim 8, wherein said note path is stepped or offset, to prevent tampering by means of foreign objects and to reduce the effect of ambient light shining into the note path.

11. Apparatus according to claim 1, wherein said scan head means is one or a pair of complementary scan heads having a plurality of optical and/or magnetic sensors each adapted to record a response trace for the note as it passes.

12. Apparatus according to claim 1, wherein said scan head means is mounted for scanning movement over the respective note, as it traverses said zone, to vary its X-Y co-ordinates along the note.

13. A method of identifying and validating a currency note including: identifying at least one position parameter of the note as it traverses a note path; in dependence on identification of said at least one position parameter, inspecting a selected first zone of the note for making a provisional identification of the note; and inspecting a second zone of the note selected in dependence on said provisional identification and on said identification of the position parameter, for validating said provisional identification.

14. A method according to claim 13 wherein said first zone is a zone laterally of the note.

15. A method according to claim 14, wherein said first zone is a linear zone.

16. A method according to claim 13, wherein said first zone is common for all denominations of a currency set.

17. A method according to claim 16, wherein said second zone is a zone longitudinally of the note.

18. A method according to claim 17, wherein said second zone is a variable between denominations of the same currency set.

19. A method according to claim 13, wherein said second zone is such that the scan head means relatively adjusts its position laterally of the note as the second zone is inspected.

20. A method according to claim 13 wherein said first zone of the note is selected to enhance or optimise the likelihood that the provisional identification of the note is correct.

21. A method according to claim 20 wherein said selection takes into account an expectation that the notes are likely to be, or required to be, of a particular currency or range of currencies.

22. A method according to claim 21, wherein said selection is made by comparison of one or more sensor values for the first zone with pre-stored known data for the first zone.

23. A currency note validation apparatus including: means defining a note path from presentation position; sensor means to identify at least one position parameter of a note as it traverses said note path; and scan head means positionable to inspect a zone of the note selected in dependence on said identification of said position parameter, for validating said note; wherein said zone is such that the scan head means relatively adjusts its position laterally of the note as the zone is inspected.

24. Apparatus according to claim 23 wherein said scan head means comprises separate scan head or sets of scan heads for the inspection of both the first and second zones.

25. Apparatus according to claim 23 wherein said scan head means comprises separate scan heads or sets of scan heads for the respective first and second zones.

26. Apparatus according to claim 23, further including means to propel the note along said note path.

27. Apparatus according to claim 26, wherein said means defining the note path is a housing and said presentation position is a slot opening into said housing.

28. Apparatus according to claim 26, wherein said note path is stepped or offset, to prevent tampering by means of foreign objects and to reduce the effect of ambient light shining into the note path.

29. Apparatus according to claim 23, wherein said scan head means is one or a pair of complementary scan heads having a plurality of optical and/or magnetic sensors each adapted to record a response trace for the note as it passes.

30. Apparatus according to claim 23, wherein said scan head means is mounted for X-Y scanning movement over the respective note, as it traverses said zone, which typically varies its X-Y co-ordinates along the note.

31. Apparatus according to claim 1, wherein said second zone is a zone longitudinally of the note.

32. Apparatus according to claim 31, wherein said second zone is such that the scan head means relatively adjusts its position laterally of the note as the second zone is inspected.

33. Apparatus according to claim 1, wherein said means defining the note path is a housing and said presentation position is a slot opening into said housing.

34. Apparatus according to claim 1, wherein said note path is stepped or offset, to prevent tampering by means of foreign objects and to reduce the effect of ambient light shining into the note path.

35. Apparatus according to claim 6, wherein said scan head means is one or a pair of complementary scan heads having a plurality of optical and/or magnetic sensors each adapted to record a response trace for the note as it passes.

36. Apparatus according to claim 7, wherein said scan head means is one or a pair of complementary scan heads having a plurality of optical and/or magnetic sensors each adapted to record a response trace for the note as it passes.

37. Apparatus according to claim 6, wherein said scan head means is mounted for scanning movement over the respective note, as it traverses said zone, to vary its X-Y co-ordinates along the note.

38. Apparatus according to claim 7, wherein said scan head means is mounted for scanning movement over the respective note, as it traverses said zone, to vary its X-Y co-ordinates along the note.

39. Apparatus according to claim 11, wherein said scan head means is mounted for scanning movement over the respective note, as it traverses said zone, to vary its X-Y co-ordinates along the note.

40. A method according to claim 16, wherein said second zone is variable between denominations of the same currency set.

41. A method according to claim 1, wherein said second zone is a zone longitudinally of the note.

42. A method according to claim 1, wherein said second zone is variable between denominations of the same currency set.

43. A method according to claim 20, wherein said selection is made by comparison of one or more sensor values for the first zone with pre-stored known data for the first zone.

44. Apparatus according to claim 23, wherein said means defining the note path is a housing and said presentation position is a slot opening into said housing.

45. Apparatus according to claim 23, wherein said note path is stepped or offset, to prevent tampering by means of foreign objects and to reduce the effect of ambient light shining into the note path.

46. Apparatus according to claim 24, wherein said scan head means is one or a pair of complementary scan heads having a plurality of optical and/or magnetic sensors each adapted to record a response trace for the note as it passes.

47. Apparatus according to claim 25, wherein said scan head means is one or a pair of complementary scan heads having a plurality of optical and/or magnetic sensors each adapted to record a response trace for the note as it passes.

48. Apparatus according to claim 24, wherein said scan head means is mounted for X-Y scanning movement over the respective note, as it traverses said zone, which typically varies its X-Y co-ordinates along the note.

49. Apparatus according to claim 25, wherein said scan head means is mounted for X-Y scanning movement over the respective note, as it traverses said zone, which typically varies its X-Y co-ordinates along the note.

50. Apparatus according to claim 29, wherein said scan head means is mounted for X-Y scanning movement over the respective note, as it traverses said zone, which typically varies its X-Y co-ordinates along the note.
